(19) United States
(12) Patent Application Publication
(10) Pub. No.: US 2018/0230353 A1
(43) Pub. Date: Aug. 16, 2018

(54) BORON NITRIDE WITH CONTROLLED BORON OXIDE LEVELS

(71) Applicant: SAINT-GOBAIN CERAMICS & PLASTICS, INC., Worcester, MA (US)

(72) Inventors: Nabil NAHAS, Waltham, MA (US); Sarah PLAIN, Worcester, MA (US); Ryan KOSESKI, Buffalo, NY (US); Stephen BOTTIGLIERI, Whitinsville, MA (US)

(73) Assignee: SAINT-GOBAIN CERAMICS & PLASTICS, INC., Worcester, MA (US)

(21) Appl. No.: 15/893,443

(22) Filed: Feb. 9, 2018

Related U.S. Application Data
(60) Provisional application No. 62/457,379, filed on Feb. 10, 2017.

(51) Int. Cl. C09K 5/14; C09C 1/00; C08K 3/38

(52) U.S. Cl. CPC C09K 5/14; C09C 1/0081; C08K 3/38; C08K 2201/005; C08K 2003/387; C08K 2201/001; C08K 2201/006; C08K 2003/385

(57) ABSTRACT

The present disclosure is directed to a boron nitride powder with a controlled boron oxide level and method of making such powder. The method of making the BN—B₂O₃ powder can include heat treating a high fired boron nitride powder at a temperature of 800-1200° C. for a period of 0.5-5 hours. The BN—B₂O₃ powder disclosed herein has low attrition, high strength, good flow behavior, high resistance to hydration, and low ionic conductivity.

### REFERENCE TO RELATED APPLICATIONS

This application claims the benefit of U.S. Provisional Application No. 62/457,379, filed Feb. 10, 2017, the entire contents of which are incorporated herein by reference.

### FIELD OF THE INVENTION

This disclosure relates to boron nitride powder and applications using said powder. More particularly, this disclosure relates to boron nitride powder with controlled boron oxide levels.

### BACKGROUND OF THE INVENTION

Boron nitride has a variety of uses including in thermal management applications (e.g., used as a filler in a polymer matrix for thermosets, thermoplastics, elastomers, etc.), electrical insulation applications, corrosion resistant applications, plastic additives, and lubricant applications, among others. In addition, boron nitride compounds can be used to make various ceramic materials. For example, boron nitride can be used as a gas and electrical barrier within a gas sensor (e.g., lambda oxygen sensor).

BN powder mixed with crushed B₂O₃ can lead to an unsatisfactory level of homogeneity for thermal management applications and ceramic applications. When BN powder is mixed with crushed B₂O₃, the B₂O₃ can be external to the aggregates rather than evenly dispersed within them. This can cause uneven melting during sintering of a pressed component leading to porosity in the final part. In thermal management applications, the aggregates of powder would not be altered by the addition of the B₂O₃ and therefore would not exhibit any improved mechanical properties (e.g., attrition resistance).

### SUMMARY OF THE INVENTION

Applicants have discovered a flowable and high purity BN—B₂O₃ powder that has low attrition, high strength, good flow behavior, high resistance to hydration, and low ionic conductivity. Accordingly, the BN—B₂O₃ powder disclosed herein can be suitable for a wide variety of thermal management applications. For example, the BN—B₂O₃ powder can be used as a filler in a polymer matrix to improve the properties of various thermosets, thermoplastics, elastomers, etc.

In addition, BN—B₂O₃ powder disclosed herein can be used to form pressureless sintered net shapes. Accordingly, the BN—B₂O₃ powder can be ready to press by a ceramic processor into a wide variety of shapes instead of relying on machining to form a desired shape. In addition, the BN—B₂O₃ powder can be co-sintered with various other components in a single step instead of having to hot press the BN, machine it, apply the various other components, and resinter it again.

This disclosure refers to both particles and powders. These two terms are equivalent, except for the caveat that a singular “powder” refers to a collection of particles. The present invention can apply to a wide variety of powders and particles.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters. For example, a statement that the weight percent of oxygen can be less than 1%, 0.5%, or 0.1% is meant to mean that the weight percent of oxygen can be less than 1%, less than 0.5%, or less than 0.1%.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Additional advantages will be readily apparent to those skilled in the art from the following detailed description. The examples and descriptions herein are to be regarded as illustrative in nature and not restrictive.

### BRIEF DESCRIPTION OF THE DRAWINGS

Exemplary embodiments are described with reference to the accompanying figures, in which:

FIG. 1 illustrates an image of BN powder flowing through the hot zone of the rotary kiln.

FIG. 2 illustrates an image of a muffle furnace used for some of the Examples described herein.

FIG. 3 illustrates an image of a crucible loaded with BN powder for use in a muffle furnace.

FIG. 4A illustrates an image of a closed elevator furnace with platform raised into the hot zone used for some of the Examples described herein.

FIG. 4B illustrates an image of a platform set up with a raised sagger of an elevator furnace used for some of the Examples described herein.

FIG. 5 illustrates an image of a sagger loaded with BN powder for use in an elevator furnace.

FIG. 6 is a graph of the B₂O₃ content as a function of time fired at 1050° C. in the elevator kiln per Examples described herein.

FIGS. 7A-7F are scanning electron microscope (SEM) images of a cross-section of the BN—B₂O₃ powder of Example 5.

FIG. 8A is an EDS mapping image displaying oxygen content of a cross-section of the BN—B₂O₃ powder of Example 5.

FIG. 8B is an EDS mapping image displaying carbon, nitrogen, boron, and oxygen content of a cross-section of the BN—B₂O₃ powder of Example 5.

FIG. 8C is an EDS mapping image displaying boron content of a cross-section of the BN—B₂O₃ powder of Example 5.

FIG. 8D is an EDS mapping image displaying nitrogen content of a cross-section of the BN—B₂O₃ powder of Example 5.

### DETAILED DESCRIPTION OF THE INVENTION

Applicants have discovered a flowable and high purity boron nitride (BN) powder with a controlled boron oxide (B₂O₃) level and method of making such powder. Furthermore, the BN—B₂O₃ powder disclosed herein has low attrition, high strength, good flow behavior, high resistance to hydration, and low ionic conductivity. Accordingly, the BN—B₂O₃ powder can be used in a wide variety of thermal management application and can be ready to press by a ceramic processor into a wide variety of shapes instead of relying on machining to form a desired shape.

Boron nitride is known to oxidize to boron oxide in oxygen environments at elevated temperature. However, the oxidation of boron nitride to B₂O₃ can follow several pathways. These pathways can lead to the direct conversion of BN to B₂O₃ from either oxygen or H₂O. Boron nitride conversion to boron oxide can be driven by two main phenomena: (1) kinetics of reaction that decrease rapidly past a given conversion percentage due to a protecting B₂O₃ passivation layer forming; and (2) secondary reactions of the B₂O₃ with water to form volatile compounds. Due to these various competitive reaction pathways, controlled oxidation of BN is difficult.

The reactivity to water can result in several gaseous species that form at the expense of B₂O₃. In addition, non-gaseous hydrogen-based species, such as H₃BO₃ or HBO₂ can impact sintering by releasing water or ionic conductivity in thermal management applications. The rate at which B₂O₃ growth occurs as compared to its volatilization when in contact with water (among other factors such as feed material variability and oxygen and water partial pressure in the furnace) was considered when Applicants developed their reproducible method for controlling the oxidation of BN.

The reactivity of BN and subsequent reactivity of formed B₂O₃ can be described in two stages: (1) initial reaction of BN to B₂O₃; and (2) secondary reaction of B₂O₃ to HBO₂ gas. The phase of boron nitride can impact the temperature and rate at which each reaction occurs. For example, disordered boron nitride (turbostratic) tends to have a weight loss between 900-1200° C. which can indicate rapid BN→B₂O₃ (l,s)→H—B—O (g) transformation. In contrast, the more ordered hexagonal boron nitride can gain weight over this temperature range linearly. However, after 1200° C., the hexagonal boron nitride can lose weight rapidly.

The time it takes for the weight gain or weight loss in the BN powder can vary drastically. This discrepancy may be explained by considerations such as a variation in surface area and the purity of the tested material. In addition, the increase in temperature and surface area of the BN can affect the oxidation rate of the BN. For example, the oxidation rate of BN powders with a particle size difference between 1-10 μm can provide a difference in approximately the same order of magnitude in time.

Furthermore, the moisture content present during oxidation can affect the BN oxidation process. For example, a paralinear kinetic behavior can occur when water is present. Kinetics which follow a paralinear behavior can be caused by the parabolic weight gain of B₂O₃ scale build-up and the linear weight loss to HBO₂ gas occurring at the same time. This paralinear behavior can be consistent regardless of the geometrical properties of the BN tested.

Accordingly, oxidation to B₂O₃ can be more strongly driven by oxygen than water; a paralinear kinetic behavior can occur when there is a presence of water (water can force a reduction in weight change due to volatized B₂O₃ and the rate of which increases with increasing moisture content); and the oxidation time can vary depending on surface area/size of the BN particles and the temperature used for oxidation.

BN powder mixed with crushed B₂O₃ leads to an unsatisfactory level of homogeneity for thermal management applications and pressureless sintering. When BN powder is mixed with crushed B₂O₃, the B₂O₃ can be external to the aggregates rather than evenly dispersed within them. This can cause uneven melting during sintering of a pressed component leading to porosity in the final part or, in the case of an oxygen sensor, insufficient gas impermeability. In thermal management applications, the aggregates would not be altered by the addition of the B₂O₃ and therefore would not exhibit any improved mechanical properties (e.g., attrition resistance). Accordingly, Applicants discovered a method of forming a BN—B₂O₃ powder wherein the B₂O₃ can be in its anhydrous form and can be homogenously distributed at the BN platelet level. One method of achieving this is by oxidizing the BN powder directly via heat treatment in air.

### BN Starting Material

The starting material to form the BN—B₂O₃ powder can be a BN powder including a hexagonal BN powder. As such, the boron nitride in the final BN—B₂O₃ powder can also be hexagonal. In addition, the BN powder can be a high fired BN powder. “High fired” is understood to refer to a process of treating a material with heat such as a sintering type process. Accordingly, the high fired BN powder can be BN powder that has previously been sintered. In some embodiments, high fired BN powder is formed by firing BN powder at a temperature above 1600° C. under an inert atmosphere. In some embodiments, the inert atmosphere comprises or consists of nitrogen gas. The high fired BN powder can have a relatively low surface area (or large platelet size) when compared to other BN powders and the high fired BN powder can be aggregated (i.e., the platelets are “sintered” together to maintain a certain level of strength). For example, the surface area of the high fired BN powder can be about 1-10 m²/g, about 1-5 m²/g, about 2-5 m²/g, about 2-4 m²/g, about 3-4 m²/g, or about 3.7 m²/g. In some embodiments, the surface area of the high fired BN powder can be less than about 10 m²/g, about 7 m²/g, about 5 m²/g, or about 4 m²/g. The relatively low surface area can provide multiple benefits during the subsequent oxidation step. For example, after oxidation, the low surface area can reduce subsequent hydration such that the BN—B₂O₃ powder remains stable. In addition to the resistance to hydration, low surface area can lead to low resin uptake and lower viscosity in thermal management applications. For an oxygen sensor, the lower surface area can provide a better pressing ability (i.e., no delamination of the pressed compact).

The high fired BN powder can have a platelet diameter of about 1-50 microns, about 2-40 microns, about 5-30 microns, about 7-20 microns, or about 10 microns. In some embodiments, the high fired BN powder can have a platelet diameter less than about 50 microns, about 40 microns, about 30 microns, about 25 microns, about 20 microns, about 15 microns, about 12 microns, or about 10 microns. In addition, the individual particles of the high fired BN powder can be aggregated to form aggregates that have a size of about 25-300 microns, about 50-250 microns, about 25-200 microns, about 50-150 microns, about 75-125 microns, about 90-110 microns, or about 100 microns. In some embodiments, the individual particles of the high fired BN powder can be aggregated to form aggregates that have a size of less than about 500 microns, about 400 microns, about 300 microns, about 250 microns, about 200 microns, about 150 microns, about 125 microns, about 110 microns, about 100 microns, about 90 microns, about 75 microns, about 50 microns, about 25 microns. In some embodiments, the high fired BN powder can be sieved so that only a certain size powder is used.

The high fired BN powder can also have a low density. For thermal management applications, a low density powder can provide a higher volume fraction at a given weight loading which in turn can provide a higher thermal conductivity at a weight fraction. For an oxygen sensor application, the low density powder allows for better pressing ability. A too dense powder may be too hard (because of boron oxide) and can generate porosity in the final ceramic upon sintering. The high fired BN powder can have a tap density of about 0.1-1, about 0.2-0.8, about 0.3-0.7, about 0.4-0.6, about 0.5, or about 0.51. In some embodiments, the tap density of the high fired BN powder is less than about 0.75, about 0.7, about 0.65, about 0.6, about 0.55, about 0.53, about 0.51, about 0.5. In addition, the high fired BN powder can have a bulk density of about 0.5-2; about 0.75-1.5, about 0.75-1.25, about 0.9-1.1, about 1, or about 1.1. In some embodiments, the bulk density of the high fired BN powder is less than about 2, about 1.5, about 1.25, about 1.2, about 1.15, or about 1.1.

The high fired BN powder may also have an initial oxygen content. Typically, the oxygen content is less than about 1 wt %, about 0.75 wt %, about 0.5 wt %, about 0.25 wt %, about 0.2 wt %, about 0.15 wt %, or about 0.1 wt %. In some embodiments, the oxygen content is about 0.01-0.5 wt %, about 0.01-0.25 wt %, about 0.01-0.2 wt %, about 0.01-0.1 wt %. In some embodiments, the oxygen content of the high fired BN powder can be about 0.2 wt %. This initial oxygen can also be in the form of B₂O₃. The B₂O₃ content of the high fired BN powder can be less than about 0.2 wt %, about 0.15 wt %, about 0.1 wt %, or about 0.05 wt %, or about 0.025 wt %. In some embodiments, the B₂O₃ content of the high fired BN powder can be about 0.001-0.1 wt %, about 0.005-0.1 wt %, about 0.01-0.05 wt %, or about 0.02 wt %. The high fired BN powder may include impurities. For example, these impurities can include alkali elements, alkali earth elements, or combinations thereof. These elements can generate ionic conductivity in thermal management applications and hinder the sintering of ceramics. However, these impurities combined can be less than about 2000 ppm, about 1500 ppm, about 1000 ppm, or about 500 ppm of the high fired BN powder.

The high fired BN powder can also be porous. The porosity can provide the compliance such that the final BN—B₂O₃ powder is ready to press. For thermal management applications, a porous powder can provide a higher volume fraction at a given weight loading which in turn can provide a higher thermal conductivity at a weight fraction. For an oxygen sensor application, the porosity can allow for better pressing ability. The high fired BN powder can have an open porosity of about 30-80%, about 40-70%, about 40-60%, about 50-60%, or about 55%. In some embodiments, the porosity of the high fired BN powder is less than about 90%, about 80%, about 75%, about 70%, about 65%, about 60%, about 57%, about 55%, about 53%, about 50%, about 45%, about 40%, about 35%, or about 30%. In some embodiments, the porosity of the high fired BN powder is more than about 90%, about 80%, about 75%, about 70%, about 65%, about 60%, about 57%, about 55%, about 53%, about 50%, about 45%, about 40%, about 35%, or about 30%.

The high fired BN powder can also be spherical in shape. The spherical nature of the powder can improve packing of the powder. By increasing the powder loading, an increase in thermal conductivity can be achieved. The high fired BN powder can have a sphericity greater than about 0.5, about 0.75, about 0.8, about 0.85, about 0.90, or about 0.95.

In addition, the high fired BN powder can have superior flowability. An improvement in flowability can increase the quality of the pressed part and therefore improve gas impermeability of the pressed part. As such, the subsequent BN—B₂O₃ powder can later be easily loaded and pressed in a mold. The high fired BN powder can have a flowability for 25 grams of powder of about 20-120 seconds, about 30-110 seconds, about 40-100 seconds, about 40-90 seconds, about 40-80 seconds, about 45-75 seconds, or about 50-70 seconds. In contrast to high fired BN powder, raw BN powder may not be flowable. In some embodiments, the high fired BN powder is PCTL7MHF commercially produced by Saint-Gobain.

In some embodiments, the high fired BN powder can be mixed with other additives prior to oxidation heat treatment. These additives can include transition metals, lanthanoids, actinoids, post-transition metals, metalloids, other non-metals, and their hydroxides, oxides, or combinations thereof. For example, boehmite, alumina, or yttrium oxide can be added to the high fired BN powder prior to oxidation heat treatment. These additives can be added to the high fired BN powder in an amount of about 0.01-5 wt %, about 0.05-1 wt %, or about 0.1-0.5 wt % the combination of high fired BN powder and additives. In some embodiments, the additives can be added to the high fired BN powder in an amount of at most about 5 wt %, about 3 wt %, about 1 wt %, about 0.75 wt %, or about 0.5 wt % additives the combination of high fired BN powder and additives.

Heat Treatment of BN Powder to form BN—B₂O₃ Powder

Applicants have discovered that firing the BN powder described above under specific conditions can form a BN—B₂O₃ powder with low attrition (i.e., high attrition resistance), high strength, good flow behavior, high resistance to hydration, and low ionic conductivity. As described above, the BN powder can include minor amount of B₂O₃. However, this amount can be too low to provide the powder with the benefits previously described. Instead, the target boron oxide content of the powder is about 1-10 wt %, about 1-6 wt %, about 1-5 wt %, about 2-6 wt %, about 2-5 wt %, about 3-6 wt %, or about 3-5 wt %. If the boron oxide content is below the target boron oxide content, the BN—B₂O₃ powder can have a low attrition resistance, low strength, higher viscosity, and lower thermal conductivity in thermal management applications. If the boron oxide content is above the target boron oxide content, the thermal conductivity when using the BN—B₂O₃ powder in a thermal management application would decrease and the BN—B₂O₃ powder can show higher ionic conductivity and hydration resistance (hence decrease the volume resistivity when added into a polymer).

When used in an oxygen sensor, the low boron oxide content can lead to poor densification upon sintering of the sensor, thereby creating a sensor with low gas impermeability as well as low mechanical properties of the sintered sensor. A high boron oxide content above the target boron oxide content can also lead to poor packing/powder loading and poor pressability, thereby decreasing mechanical properties of sintered part.

In order to obtain the target boron oxide content of the powder, Applicants developed a heat treatment method to oxidize the BN powder described above. As such, the BN—B₂O₃ powder can include about 90-99 wt %, about 94-99 wt %, about 95-99 wt %, about 94-99 wt %, about 94-98 wt %, about 95-98 wt %, about 95-97 wt % boron nitride. In addition, the structural composition of the BN—B₂O₃ powder can include at least about 90%, about 94%, about 95%, about 96%, about 97%, about 98%, or about 99% boron nitride (based on total weight of all crystalline phases). In some embodiments, the BN—B₂O₃ powder can include additives as described above. In some embodiments, the BN—B₂O₃ powder can include about 0.01-5 wt %, about 0.05-1 wt %, or about 0.1-0.5 wt % additives. In some embodiments, BN—B₂O₃ powder can include at most about 5 wt %, about 3 wt %, about 1 wt %, about 0.75 wt %, or about 0.5 wt % additives.

Various devices can be used in the oxidation heat treatment of the BN powder including a rotary kiln, a muffle furnace, an elevator kiln, or a pusher kiln, among others. Although various devices can be used to heat treat the BN powder, there are main components of the oxidation heat treatment. These main components can include, for example, the partial pressure of oxygen in the oxidation heat treatment, the partial pressure of water in the oxidation heat treatment, the BN powder bed height of the oxidation heat treatment, and the temperature (at hold time) including the heating rate and cooling rate of the oxidation heat treatment. As previously described, due to the various competitive reaction pathways, controlled oxidation of BN is difficult. Accordingly, the main components of the oxidation heat treatment can allow the BN powder to be oxidized to the target boron oxide content and allow the boron oxide content to stay in the final BN—B₂O₃ powder after it is cooled down to room temperature.

The partial pressure of oxygen in the oxidation heat treatment can directly impact the amount of oxidation of the BN powder. Without sufficient oxygen, the BN powder cannot become oxidized. Thus, the partial pressure of oxygen in the oxidation heat treatment can be at least about 50 Pa, at least about 75 Pa, at least about 90 Pa, at least about 100 Pa. Below these partial pressures, insufficient oxidation can occur. In some embodiments, the partial pressure of oxygen in the oxidation heat treatment can be between about 100-10⁵ Pa. In some embodiments, the atmosphere of the oxidation heat treatment can be pure oxygen.

As previously described, the partial pressure of water in the oxidation heat treatment can lead to the formation of hydroxides in the BN powder which can vaporize, thereby depleting the amount of BN—B₂O₃ powder obtained. As such, the partial pressure of water in the oxidation heat treatment can be at most about 2000 Pa, about 1500 Pa, about 1250 Pa, or about 1000 Pa. Above these partial pressures, significant hydration can occur. In some embodiments, the partial pressure of water in the oxidation heat treatment can be about 1-1000 Pa. In some embodiments, the atmosphere of the oxidation heat treatment is ambient atmospheric conditions (i.e., air).

The BN powder bed height used in the oxidation heat treatment can play an important role on the homogeneity of the B₂O₃ within the BN—B₂O₃ powder. As discussed above, previous attempts to form BN—B₂O₃ included using BN powder mixed with crushed B₂O₃. The BN powder mixed with crushed B₂O₃ had unsatisfactory performance when used in an oxygen sensor. If the bed height is too thick/tall, the B₂O₃ content at the surface of the bed can be different than the B₂O₃ content at the bottom of the bed. The BN powder bed height used in the oxidation heat treatment can be at most about 10 cm, about 8 cm, about 5 cm, about 2.5 cm, about 1 cm, about 0.635 cm, or about 0.5 cm.

The temperature of the oxidation heat treatment also can directly affect the B₂O₃ within the formed BN—B₂O₃ powder. For example, if the temperature is too high even with low humidity, the BN powder may still form hydroxides and volatilize. The temperature applied to the BN powder in the oxidation heat treatment can be about 800-1200° C., about 900-1100° C., about 1000-1100° C., about 1025-1075° C., or about 1050° C. If the temperature is too low, no significant oxidation can occur in a realistic time frame (e.g., days). If the temperature is too high, oxidation may not be controllable (i.e., catastrophic oxidation). In some embodiments, the temperature applied to the BN powder in the oxidation heat treatment is less than about 1200° C., about 1175° C., about 1150° C., about 1125° C., about 1100° C., about 1090° C., about 1080° C., about 1070° C., about 1060° C., about 1055° C., about 1050° C., about 1045° C., about 1040° C., about 1030° C., about 1020° C., about 1010° C., about 1000° C., about 975° C., about 950° C., about 925° C., about 900° C., about 875° C., about 850° C., about 825° C., or about 800° C. In some embodiments, the temperature applied to the BN powder is greater than about 800° C., about 850° C., about 875° C., about 900° C., about 925° C., about 950° C., about 975° C., about 1000° C., about 1010° C., about 1020° C., about 1030° C., about 1040° C., about 1045° C., about 1050° C., about 1055° C., about 1060° C., about 1070° C., about 1080° C., about 1090° C., about 1100° C., about 1125° C., about 1150° C., or about 1175° C.

The hold time at this temperature can be about 5 minutes to 5 hours, about 30 minutes to about 5 hours, or about 1-5 hours. In some embodiment, the hold time at this temperature is about 0.25 hour, about 0.5 hour, about 1 hour, about 2 hours, about 3 hours, about 4 hours, or about 5 hours. In some embodiment, the hold time at this temperature is less than about 0.25 hour, about 0.5 hour, about 1 hour, about 2 hours, about 3 hours, about 4 hours, or about 5 hours. The heating rate to obtain these temperatures can be about 25-1000° C./hr, about 50-750° C./hr, about 100-600° C./hr, about 100-500° C./hr, or about 300-500° C./hr. In some embodiments, the heating rate to obtain these temperatures can be about 100° C./hr, 200° C./hr, 300° C./hr, 400° C./hr, 500° C./hr, or 600° C./hr. In some embodiments, the BN powder can be in the heat treatment device while the device is heating to obtain the set hold temperature.

After holding the BN powder at the designated temperature for the hold time, the oxidized powder can be cooled at a rate of about 100-500° C./hr, about 200-400° C./hr, about 250-350° C./hr, or about 300° C./hr. In some embodiments, the BN—B₂O₃ powder is cooled to room temperature. In some embodiments, the BN—B₂O₃ powder is cooled to room temperature while remaining in the heat treatment device.

Loss on ignition is the difference in weight of 1 gram of powder before and after calcination in air at 500° C. for 1 hour. Accordingly, the loss on ignition can determine if the boron oxide has hydrated because weight loss occurs when water is released from the hydrated boron oxide. When the BN powder is subject to the oxidation heat treatment, the loss on ignition at 500° C. can be less than about 5 wt. %, about 3 wt. %, about 2 wt. %, about 1 wt. %, about 0.5 wt. %, or about 0.1 wt. %.

The BN—B₂O₃ powder can have a relatively low surface area when compared to other BN powders. For example, the surface area of the BN—B₂O₃ powder can be about 1-20 m²/g, 1-10 m²/g, about 1-5 m²/g, about 2-5 m²/g, about 2-4 m²/g, or about 3-4 m²/g. Low surface area can lead to low resin uptake and lower viscosity in thermal management applications. For an oxygen sensor, the lower surface area can provide a better pressing ability (i.e., no delamination of the pressed compact). In some embodiments, the surface area of the BN—B₂O₃ powder can be about 3 m²/g. In some embodiments, the surface area of the BN—B₂O₃ powder can be less than about 10 m²/g, about 7 m²/g, about 5 m²/g, or about 4 m²/g.

The BN—B₂O₃ powder can have a platelet diameter of about 1-50 microns, about 2-40 microns, about 5-30 microns, about 7-20 microns, or about 10 microns. In some embodiments, the BN—B₂O₃ powder can have a platelet diameter less than about 50 microns, about 40 microns, about 30 microns, about 25 microns, about 20 microns, about 15 microns, about 12 microns, or about 10 microns In addition, the individual particles of the BN—B₂O₃ powder can be aggregated to form aggregates that have a size of about 25-200 microns, about 50-150 microns, about 75-125 microns, about 90-110 microns, or about 100 microns. In some embodiments, the individual particles of the BN—B₂O₃ powder can be aggregated to form aggregates that have a size of less than about 500 microns, about 400 microns, about 300 microns, about 250 microns, about 200 microns, about 150 microns, about 125 microns, about 110 microns, about 100 microns, about 90 microns, about 75 microns, about 50 microns, about 25 microns. In some embodiments, the BN—B₂O₃ powder can be sieved so that only a certain size powder is used.

The BN—B₂O₃ powder can also be porous. The porosity can provide the compliance such that the BN—B₂O₃ powder is ready to press. For thermal management applications, a porous powder can provide a higher volume fraction at a given weight loading which in turn can provide a higher thermal conductivity at a weight fraction. For an oxygen sensor application, the porosity can allow for better pressing ability. The BN—B₂O₃ powder can have an open porosity of about 30-80%, about 40-70%, about 40-60%, about 50-60%, or about 55%. In some embodiments, the porosity of the BN—B₂O₃ powder is less than about 90%, about 80%, about 75%, about 70%, about 65%, about 60%, about 57%, about 55%, about 53%, about 50%, about 45%, about 40%, about 35%, or about 30%. In some embodiments, the porosity of the BN—B₂O₃ powder is more than about 90%, about 80%, about 75%, about 70%, about 65%, about 60%, about 57%, about 55%, about 53%, about 50%, about 45%, about 40%, about 35%, or about 30%.

The BN—B₂O₃ powder can also be spherical in shape. The spherical nature of the powder can improve packing of the powder. By increasing the powder loading, an increase in thermal conductivity can be achieved. The BN—B₂O₃ powder can have a sphericity greater than about 0.5, about 0.75, about 0.8, about 0.85, about 0.90, or about 0.95.

In addition, the BN—B₂O₃ powder can have superior flowability. An improvement in flowability can increase the quality of the pressed part and therefore improve gas impermeability of the pressed part. As such, the subsequent BN—B₂O₃ powder can be easily loaded and pressed in a mold. The BN—B₂O₃ powder can have a flowability for 25 grams of powder of about 20-120 seconds, about 30-110 seconds, about 40-100 seconds, about 40-90 seconds, about 40-80 seconds, about 45-75 seconds, or about 50-70 seconds. As such, the BN—B₂O₃ powder can be easily loaded and pressed in a mold.

The chemical composition of the BN—B₂O₃ powder can include elemental boron, elemental nitrogen, elemental oxygen, and additional elemental components. These additional elemental components can include additives or any impurities that may have formed throughout the BN—B₂O₃ powder production process. For example, these impurities can include alkali elements, alkali earth elements, or combinations thereof. The weight percent oxygen in the BN—B₂O₃ powder can be about 0.5-10%, about 1-10%, about 1-8%, about 1-7%, about 1-6%, or about 1-5%. The weight percent boron in the BN—B₂O₃ powder can be about 30-60%, about 35-55%, about 40-50%, about 40-45%, about 41-45% or about 41-44%. The weight percent nitrogen in the BN—B₂O₃ powder can be about 35-70%, about 40-65%, about 45-55%, or about 48-54%. The weight percent nitrogen in the BN—B₂O₃ powder can be about 35-70%, about 40-65%, about 45-55%, or about 48-54%. The weight percent of the impurities in the BN—B₂O₃ powder can be less than about 5%, 3%, 1%, 0.5%, or 0.1%. In some embodiments, these impurities combined can be less than about 2000 ppm, about 1500 ppm, about 1000 ppm, or about 500 ppm of the BN—B₂O₃ powder. In some embodiments, the BN—B₂O₃ powder can includes less than about 5%, 3%, 1%, 0.5%, or 0.1% of hydroxyl groups. The hydroxyl groups can include water, boric acid, or a combination thereof. These hydroxyl groups can evaporate and thus decrease the total amount of BN—B₂O₃ powder. In some embodiments, the BN—B₂O₃ powder can be in its anhydrous form.

The oxygen in the BN—B₂O₃ powder can be homogenously distributed throughout the powder. The oxygen homogeneity index can be at least about 100, about 500, or about 1000.

The wear by attrition of the BN—B₂O₃ powder can refer to how well the powder can withstand breaking down into fine particles. The wear by attrition of the BN—B₂O₃ powder can be less than about 25%, about 20%, about 15%, about 10%, about 5%, or about 1%. If the wear by attrition of the BN—B₂O₃ powder is greater than these ranges, there can be unstable rheology, high viscosity, and low thermal conductivity in thermal management applications and there can be breakage of particles during handling, poor flowability, poor pressing ability, and poor gas permeability in an gas sensor application.

The BN—B₂O₃ powder disclosed herein can be used in a variety of applications. For example, the BN—B₂O₃ powder can be used in thermal management applications (e.g., used as a filler in a polymer matrix for thermosets (e.g., silicone, epoxy, etc.), thermoplastics (e.g., polycarbonates, PTFE, PA, PEEK, etc), elastomers, etc.), electrical insulation applications, corrosion resistant applications, plastic additives, polishing applications, and lubricant applications, among others. Some of the challenges for using powder as filler in thermal management are attrition resistance that impacts thermal conductivity and water uptake and ionic conductivity that both impact compound stability. However, the BN—B₂O₃ powder disclosed herein can have low attrition, high strength, good flow behavior, high resistance to hydration, and low ionic conductivity. For example, the volume resistivity (Ω·cm) of a film made using the BN—B₂O₃ powder disclosed herein can be greater than about 10¹³, about 5×10¹³, about 10¹⁴, about 5×10¹⁴, or about 10¹⁵. In addition, the thermal conductivity (W/m·K) of a film made using the BN—B₂O₃ powder disclosed herein can be about 1-10, about 1-5, about 1.5-5, about 2-4, about 2.5-3.5, about 2-3, or about 3.

In addition, the BN—B₂O₃ powder disclosed herein can be used as a feed material to manufacture ceramic compounds. The flowable BN—B₂O₃ powder disclosed herein can be pressed to form a ceramic compound. For example, the powder can be pressed to form a portion of a gas sensor such as a seal for a gas sensor as disclosed in Application Number DE201410222365, which is hereby incorporated by reference in its entirety. Previous sensors are machined out of large, hot pressed billets of boron nitride. Boron oxide in the boron nitride billets improves gas impermeability and assists in the thermal shock resistance of the sensors. The machined BN makes up one of several layers in an oxygen sensor. Thus, after it is machined, it can be assembled and sintered with the other components. Unfortunately, hot pressing large blocks and machining them down is a costly and inefficient process. In contrast to previous sensors, the BN—B₂O₃ powder disclosed herein can be ready to press by a ceramic processor into a wide variety of shapes instead of relying on machining to form a desired shape.

### EMBODIMENTS

The following embodiments, numbered consecutively from 1 through 50 provide various embodiments described herein.

### Embodiment 1

A powder comprising: 90-99 wt % boron nitride; and 1-10 wt % boron oxide, wherein the powder has an open porosity of 30-70%.

### Embodiment 2

The powder of embodiment 1, wherein the boron oxide comprises 2-6 wt % of the powder.

### Embodiment 3

The powder of any of embodiments 1-2, wherein the powder has a surface area of 1-20 m²/g.

### Embodiment 4

The powder of embodiment 3, wherein the powder has a surface area of 1-5 m²/g.

### Embodiment 5

The powder of any of embodiments 1-4, wherein the open porosity of the powder is 40-60%.

### Embodiment 6

The powder of any of embodiments 1-5, wherein the boron oxide is homogeneously distributed in the powder.

### Embodiment 7

The powder of embodiment 6, wherein an oxygen homogeneity index of the powder is greater than 100.

### Embodiment 8

The powder of any of embodiments 1-7, wherein a sphericity of the powder is at least above 0.5.

### Embodiment 9

The powder of embodiment 8, wherein the sphericity of the powder is at least above 0.8.

### Embodiment 10

The powder of any of embodiments 1-9, wherein the powder comprises 40-45 wt % elemental boron, 45-55 wt % elemental nitrogen, and 1-10 wt % elemental oxygen.

### Embodiment 11

The powder of embodiment 10, wherein the powder comprises 41-45 wt % elemental boron, 48-54 wt % elemental nitrogen, and 1-6 wt % elemental oxygen.

### Embodiment 12

The powder of any of embodiments 1-11, wherein the powder comprises less than 5 wt % impurities.

### Embodiment 13

The powder of embodiment 12, wherein the powder comprises less than 0.1 wt % impurities.

### Embodiment 13A

The powder of embodiments 12-13, wherein the impurities comprise alkali elements, alkali earth elements, or combinations thereof.

### Embodiment 14

The powder of any of embodiments 1-13, wherein an average size of aggregates of the powder is 30-300 microns.

### Embodiment 15

The powder of embodiment 14, wherein the average size of the aggregates is 50-250 microns.

### Embodiment 16

A polymer matrix comprising the powder of embodiments 1-15.

### Embodiment 17

A ceramic material comprising the powder of embodiments 1-15.

### Embodiment 18

The ceramic material of embodiment 17, wherein the powder is pressed to form the ceramic material.

### Embodiment 19

A method of forming a BN—B₂O₃ powder comprising: heat treating a high fired boron nitride (BN) powder at a temperature of 800-1200° C. for a period of 1-5 hours.

### Embodiment 20

The method of embodiment 19, wherein an atmosphere for the heat treating has a partial pressure of oxygen of at least 100 Pa and a partial pressure of water of at most 1000 Pa.

### Embodiment 21

The method of any of embodiments 19-20, wherein the heat treating further comprising heating the high fired BN powder at a rate of 100-500° C./hr until the temperature is reached.

### Embodiment 22

The method of any of embodiments 19-21, further comprising cooling the formed BN—B₂O₃ powder at a rate of 200-400° C./hr.

### Embodiment 23

The method of any of embodiments 19-22, wherein the heat treating takes place in a rotary kiln, a muffle furnace, an elevator kiln, a box furnace, or a pusher kiln.

### Embodiment 24

The method of embodiment 23, wherein a powder bed height is below at least 5 cm.

### Embodiment 25

The method of embodiment 24, wherein the powder bed height is below at least 1 cm.

### Embodiment 26

The method of any of embodiments 19-25, wherein a loss on ignition at 500° C. during heat treating is be less than 1 wt %.

### Embodiment 27

The method of any of embodiments 19-26, wherein the high fired BN powder comprises less than 1 wt % oxygen.

### Embodiment 28

The method of any of embodiments 19-27, wherein the high fired BN powder comprises less than 0.1 wt % boron oxide.

### Embodiment 29

The method of any of embodiments 19-28, wherein the high fired BN powder has a surface area of 1-20 m²/g.

### Embodiment 30

The method of embodiment 29, wherein the high fired BN powder has a surface area of 1-5 m²/g.

### Embodiment 31

The method of any of embodiments 19-30, wherein the high fired BN powder has a porosity of 30-70%.

### Embodiment 32

The method of embodiment 31, wherein the high fired BN powder has a porosity of 40-60%.

### Embodiment 33

The method of any of embodiments 19-32, wherein the high fired BN powder has a sphericity above 0.5.

### Embodiment 34

The method of embodiment 33, wherein the high fired BN powder has a sphericity above 0.8.

### Embodiment 35

The method of any of embodiments 19-34, wherein the high fired BN powder is PCTL7MHF commercially produced by Saint-Gobain.

### Embodiment 36

The method of any of embodiments 19-35, wherein the BN—B₂O₃ powder comprises 90-99 wt % boron nitride and 1-10 wt % boron oxide.

### Embodiment 37

The method of embodiment 36, wherein the boron oxide comprises 2-6 wt % of the BN—B₂O₃ powder.

### Embodiment 38

The method of any of embodiments 19-37, wherein the BN—B₂O₃ powder has a surface area of 1-20 m²/g.

### Embodiment 39

The method of embodiment 38, wherein the BN—B₂O₃ powder has a surface area of 1-5 m²/g.

### Embodiment 40

The method of any of embodiments 19-39, wherein the open porosity of the BN—B₂O₃ powder is 40-60%.

### Embodiment 41

The method of any of embodiments 36-40, wherein the boron oxide is homogeneously distributed in the BN—B₂O₃ powder.

### Embodiment 42

The method of embodiment 41, wherein an oxygen homogeneity index of the BN—B₂O₃ powder is greater than 100.

### Embodiment 43

The method of any of embodiments 19-42, wherein a sphericity of the BN—B₂O₃ powder is at least above 0.5.

### Embodiment 44

The method of embodiment 43, wherein the sphericity of the BN—B₂O₃ powder is at least above 0.8.

### Embodiment 45

The method of any of embodiments 19-44, wherein the BN—B₂O₃ powder comprises 40-45 wt % the element boron, 45-55 wt % the element nitrogen, and 1-10 wt % the element oxygen.

### Embodiment 46

The method of embodiment 45, wherein the BN—B₂O₃ powder comprises 41-45 wt % the element boron, 48-54 wt % the element nitrogen, and 1-5 wt % the element oxygen.

### Embodiment 47

The method of any of embodiments 36-46, wherein the BN—B₂O₃ powder comprises less than 5 wt % impurities.

### Embodiment 48

The method of embodiment 47, wherein the BN—B₂O₃ powder comprises less than 0.1 wt % impurities.

### Embodiment 49

The method of any of embodiments 19-48, wherein an average size of aggregates of the BN—B₂O₃ powder is 30-300 microns.

### Embodiment 50

The method of embodiment 49, wherein the average size of the aggregates is 50-150 microns.

### EXAMPLES

### Rotary Kiln

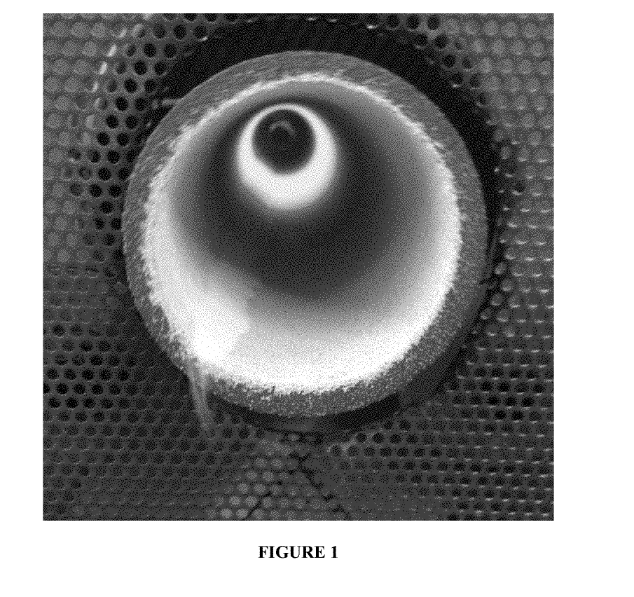

Initial testing for controlled oxidation of BN powder utilized a rotary tube furnace. The rotary tube furnace was a SiC, 3′ ID tube with a vibratory plate feeding system and a temperature limit of 1500-1700° C. depending on material corrosiveness. The rotational speed tested was from 1-3 rpm and the tilt tested was from 1-2°. The programed residence temperature of the rotary tube was from 900-1150° C. PCTL7MHF BN powder commercially produced by Saint-Gobain was continuously fed (feed amount varied) through the tube furnace into a collection at the opposite end. FIG. 1 is a picture of the BN powder flowing through the hot zone of the rotary kiln. Loss of BN powder occurred from the BN powder being blown into the air or sticking to the tube throughout the oxidation heat treatment process. In addition, the amount of BN powder in the tube was roughly maintained by the feeding system regardless of the total amount fired. After the BN powder completed its oxidation heat treatment, the obtained BN—B₂O₃ powder was mixed thoroughly and a 2 g sample was tested for oxygen and B₂O₃ content.

The following Table 2 contains the data generated during the mapping of temperature and time dependence on oxygen content of BN—B₂O₃ powder produced using the rotary kiln.

TABLE 2

| | | | Residence | | |
|---|---|---|---|---|---|
| Temperature | Tilt | Rotation | Time | Oxygen | B₂O₃ |
| (° C.) | (°) | (rpm) | (min) | (wt %) | (wt %, calculated) |
| 900 | 2 | 3 | 15 | 0.077 | 0.109 |
| 950 | 2 | 1 | 30 | 0.075 | 0.106 |
| 950 | 1 | 1 | 45 | 0.106 | 0.151 |
| 1050 | 1 | 1 | 45 | 0.26 | 0.368 |
| 1062 | 1 | 1 | 45 | 5.480 | 7.782 |
| 1150 | 1 | 1 | 45 | 48.9 | 69.44 |

As shown in Table 2, the rotary kiln furnace did not have adequate dimensions to allow sufficient residence time at the temperature range of 900−1050° C. for B₂O₃ wt % to be within 2-6 wt % of the BN—B₂O₃ powder. Note that as the temperature of the furnace went above 1050° C., there was a spike in oxygen content.

### Muffle Furnace

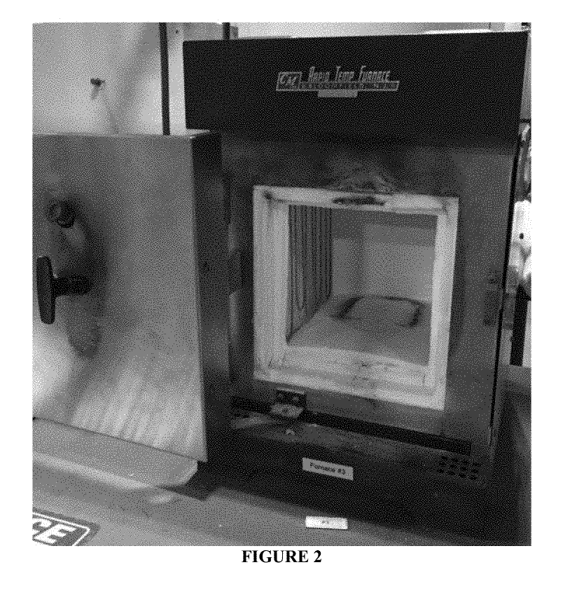

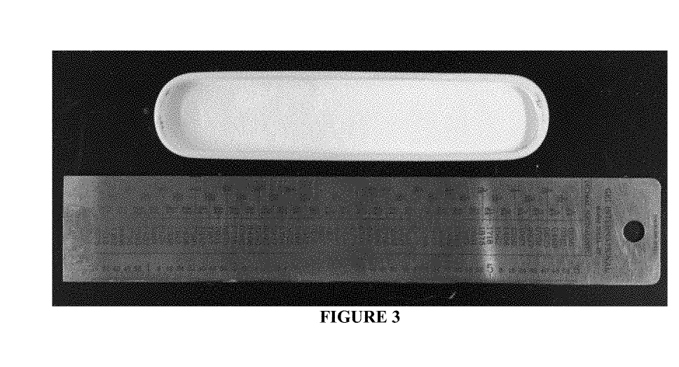

A muffle furnace (FIG. 2) was also tested as a firing vessel for the controlled oxidation of BN powder. The muffle furnace was programed such that the heat ramp was set to 10° C./min from room temperature to 1050° C. (or other desired temperature) and the hold/residence time was set. A crucible (FIG. 3) was loaded with 10 g of PCTL7MHF BN powder commercially produced by Saint-Gobain by pouring into the crucible and gently shaking to spread the powder evenly. The crucible was then loaded into the muffle furnace and the heat treatment program was initiated. The powder was allowed to free cool in the furnace back to room temperature after the hold/residence time. After cooling, the crucible was removed and the BN—B₂O₃ powder was mixed thoroughly. Two grams of the BN—B₂O₃ powder was tested for oxygen and B₂O₃ content.

The following Table 3 contains the data generated during the mapping of temperature and time dependence on oxygen content of BN—B₂O₃ powder produced using the muffle furnace.

TABLE 3

| Temperature | Residence Time | Oxygen | B₂O₃ |
|---|---|---|---|
| (° C.) | (hours) | (wt %) | (wt %, calculated) |
| 950 | 1 | 0.427 | 0.61 |
| 950 | 5 | 2.680 | 3.81 |
| 950 | 15 | 8.11 | 11.52 |
| 1050 | 0.45 | 1.35 | 1.92 |
| 1050 | 1 | 6.79 | 9.64 |
| 1050 | 5 | 23.5 | 33.37 |
| 1050 | 15 | 56.7 | 80.51 |

### Elevator Furnace

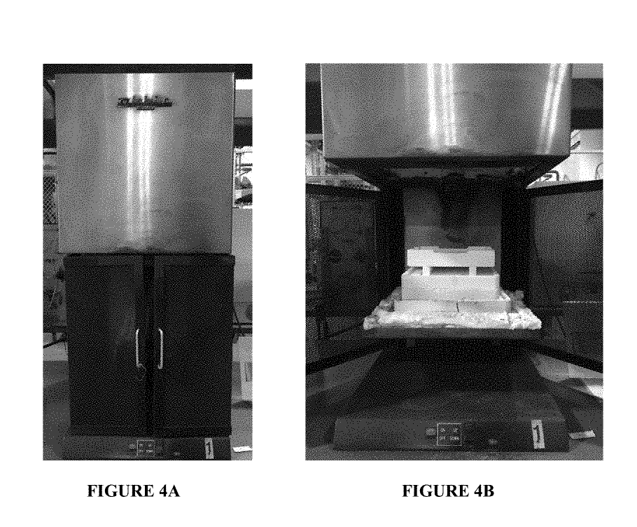

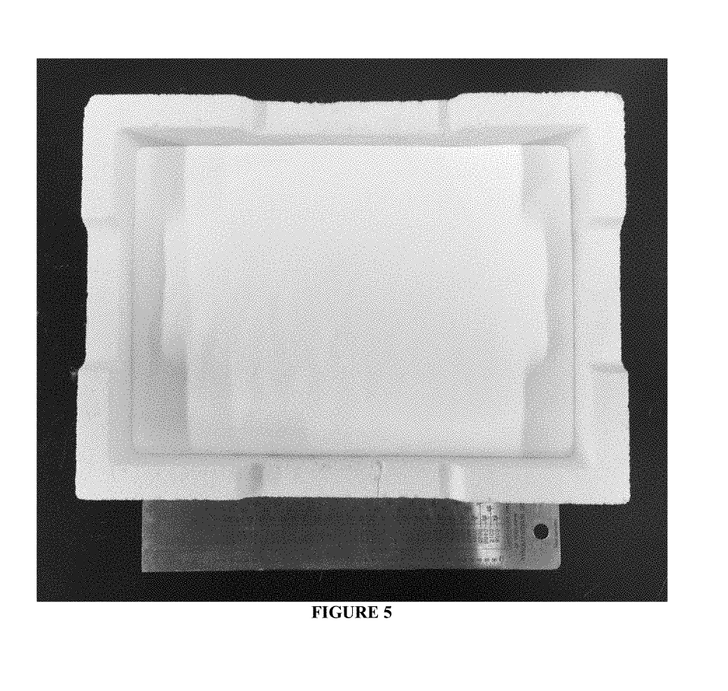

The controlled oxidation process was also tested on an elevator furnace (FIGS. 4A-4B), in which the BN powder could be introduced to a pre-heated environment to ensure rapid heating and cooling. The elevator furnace was programed to a final hold temperature of 1050° C. A sagger (FIG. 5) was loaded with 100 g of PCTL7MHF BN powder commercially produced by Saint-Gobain. The sagger was filled with the BN powder and then the powder bed was flattened such that the thickness was even and had an approximate bed height of ¼″. Using tongs and heat resistant PPE, the sagger was lifted to the elevator kiln bed. The kiln bed was then raised to close the furnace the BN powder was placed into the hot zone. The BN powder was then held at the temperature for the designated time. After the hold time was over, the kiln bed was lowered and the sagger was removed. Prior to removing, the sagger was cooled until cool enough to handle. After cooling, the BN—B₂O₃ powder was mixed thoroughly. Two grams of the BN—B₂O₃ powder was tested for oxygen and B₂O₃ content.

The following Table 4 contains the data generated by the BN—B₂O₃ powder produced using the elevator furnace.

TABLE 4

| Temperature | Time | Oxygen | B₂O₃ | B₂O₃ |
|---|---|---|---|---|
| (° C.) | (hr) | (wt %) | (wt %, calculated) | (wt %, actual) |
| 1050 | 0.9 | 1.51 | 2.14 | 1.71 |
| 1050 | 1 | 1.49 | 2.12 | 1.6 |
| 1050 | 1.1 | 2.53 | 3.59 | 3.27 |
| 1050 | 1.15 | 3.65 | 5.18 | 4.45 |
| 1050 | 1.15 | 3.04 | 4.32 | 2.92 |
| 1050 | 1.2 | 2.33 | 3.31 | 3.1 |
| 1050 | 1.25 | 3.25 | 4.62 | 3.83 |
| 1050 | 1.29 | 1.82 | 2.58 | 1.67 |
| 1050 | 1.3 | 4.55 | 6.46 | 5.22 |
| 1050 | 1.4 | 5.15 | 7.31 | 6.96 |
| 1050 | 1.5 | 6.2 | 8.80 | 8.56 |

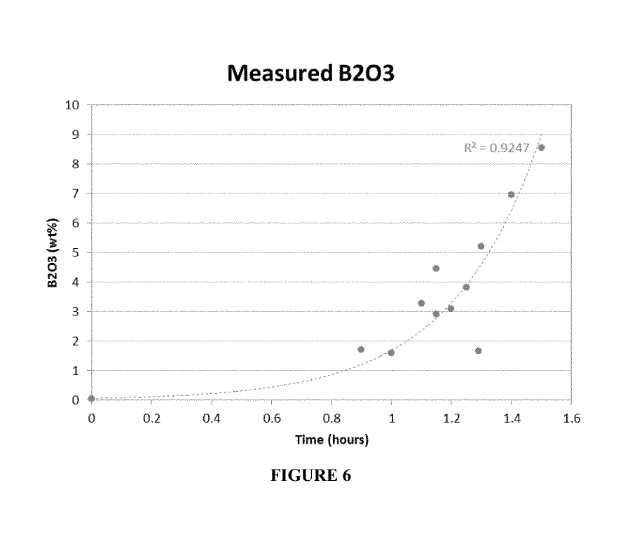

FIG. 6 is a graph of the B₂O₃ content as a function of time fired at 1050° C. in the elevator kiln. As shown in FIG. 6, the B₂O₃ content shows a slightly exponential growth trend as a function of time.

### Comparative Example 1

A stabilized boron nitride powder having an oxygen content of 7% by weight and a content of elements other than oxygen less than 1% by weight was crushed under dry conditions in a ball mill so that it has a medium size of 3 microns. The crushed powder was then sieved through a sieve having a mesh opening of 80 microns and then pressed in the form of pellets having a diameter of 50 mm using an isostatic press at a pressure of 200 MPa. The relative density of the pellets is equal to 50%. The pellets were then crushed by means of a roller mill and sieved to 150 microns and to 50 microns. The crushed pellets were then subjected to heat treatment in an elevator furnace under nitrogen in a cycle having a heating rate of 100° C./h up to 1500° C., a holding time of 2 hours at this temperature, and a descent at 300° C./h. In the end, the powder of comparative example 1 was sieved so as to keep the particle size range between 50 μm and 150 μm.

### Comparative Example 2

The powder of comparative example 2 was PCTL7MHF BN powder commercialized by Saint-Gobain.

### Comparative Example 3

PCTL7MHF BN powder commercialized by Saint-Gobain was subjected to a heat treatment in an elevator furnace under static air in a cycle having a heating rate of 300° C./h up to 1500° C., a holding time of 1 hour at this temperature, and a descent at 300° C./h. The powder bed height was 1 cm. In the end, the powder of comparative example 3 was sieved so as to keep the particle size range between 50 μm and 150 μm.

### Example 4

PCTL20MHF BN powder commercialized by Saint-Gobain was subjected to a heat treatment in an elevator furnace under static air in a cycle having a heating rate of 300° C./h up to 1000° C., a holding time of 1 hour at this temperature, and a descent at 300° C./h. The powder bed height was 1 cm. In the end, the powder of example 4 was sieved so as to keep the particle size range between 50 μm and 150 μm.

### Example 5

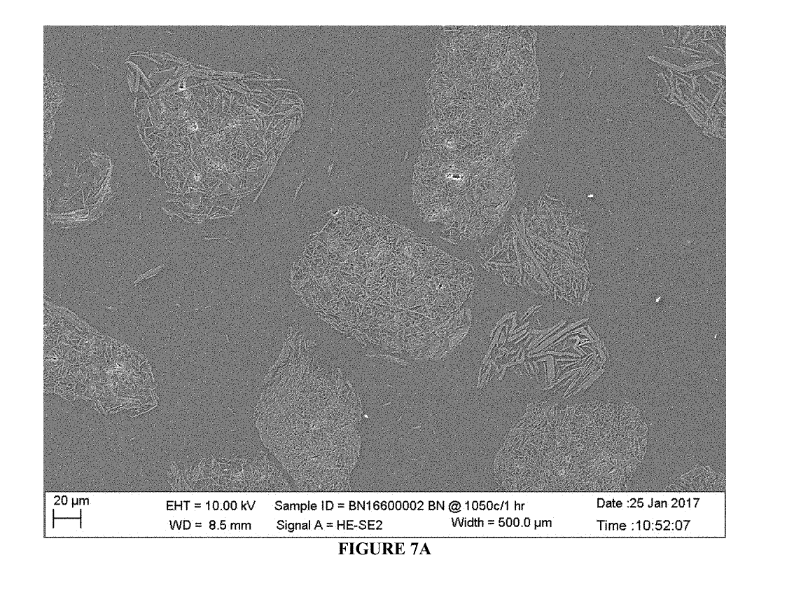

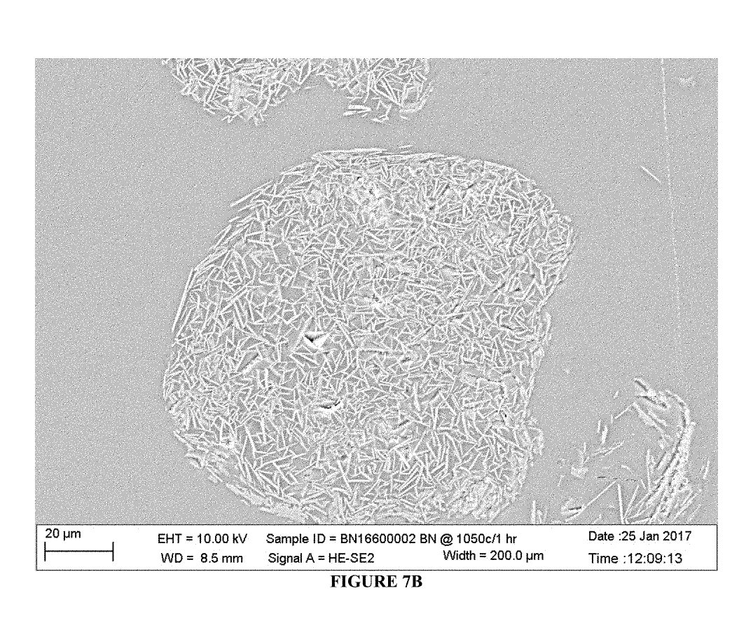

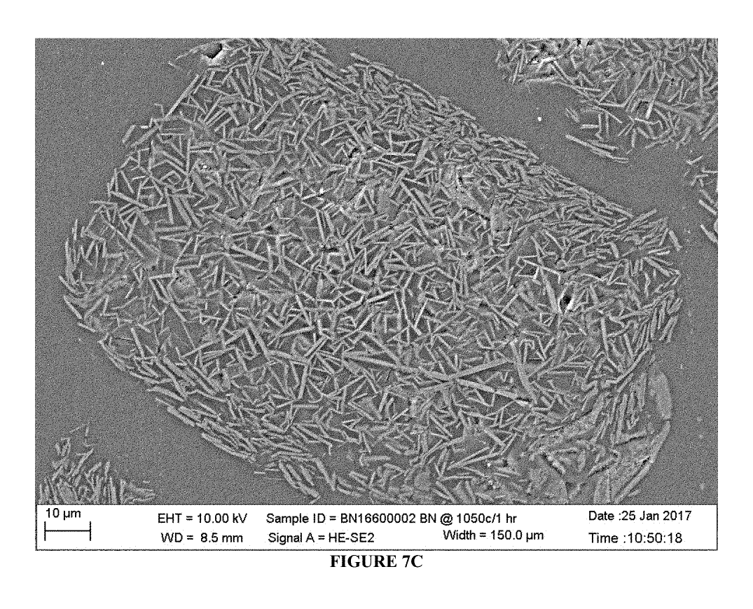

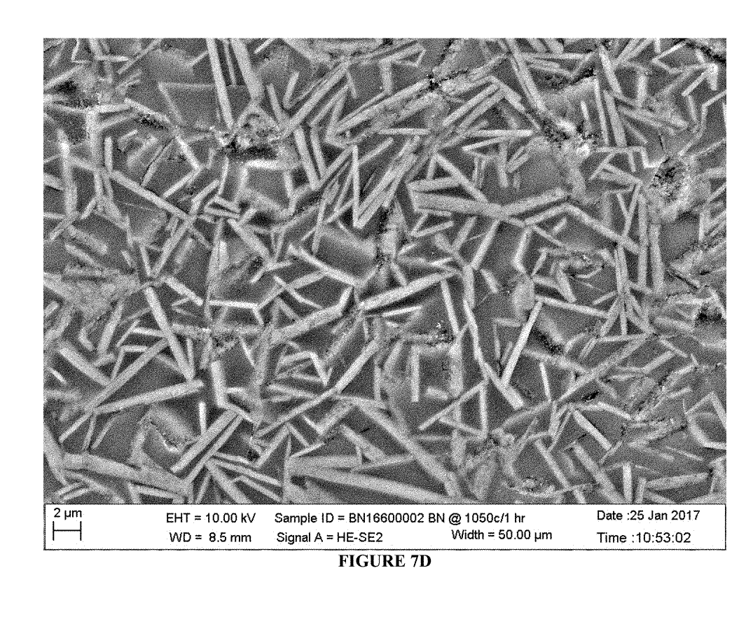

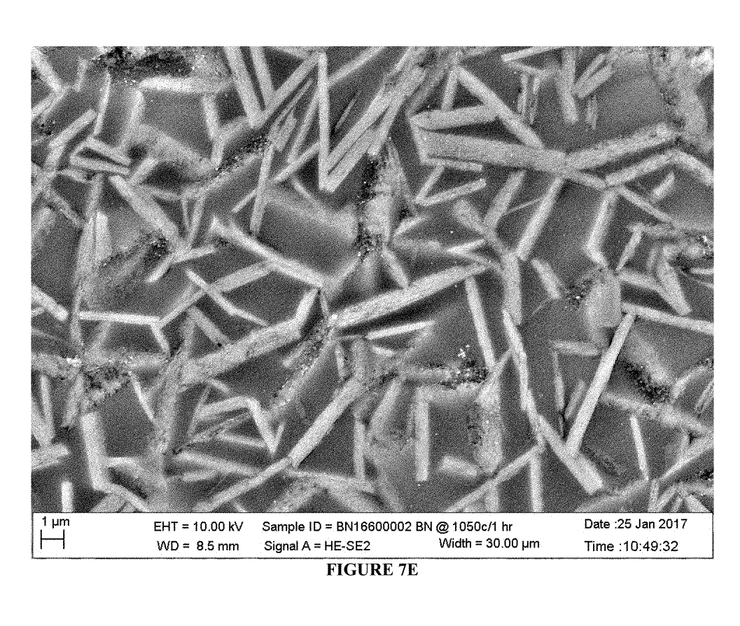

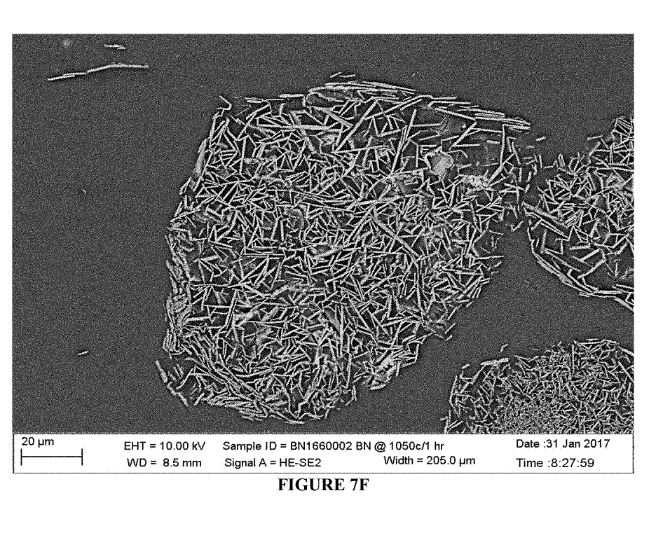

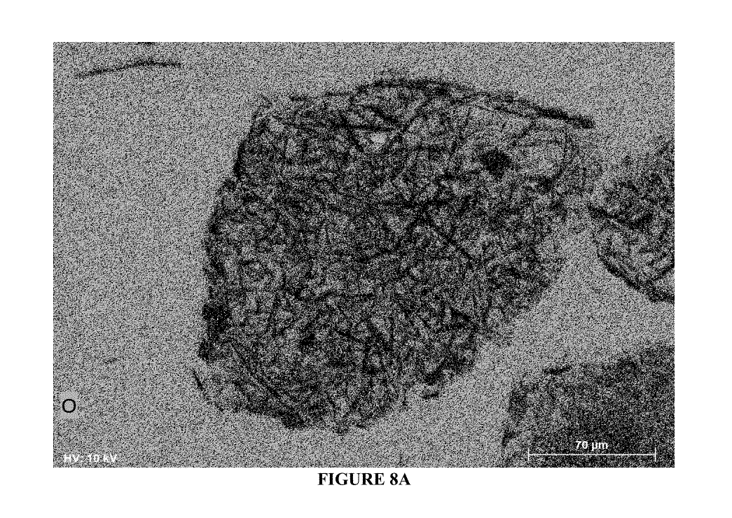

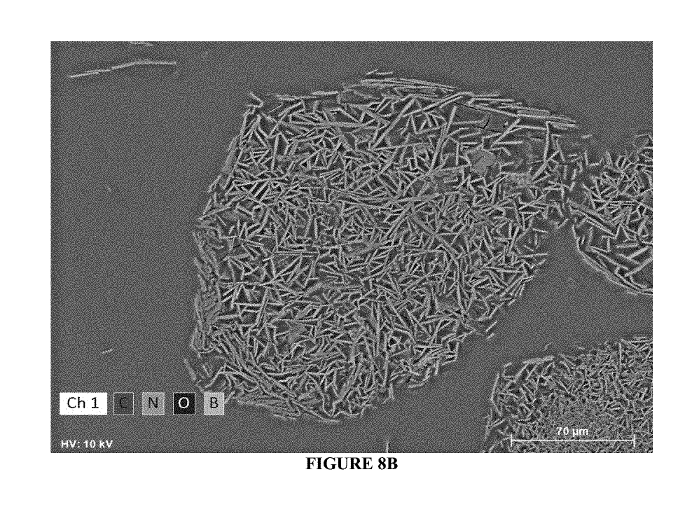

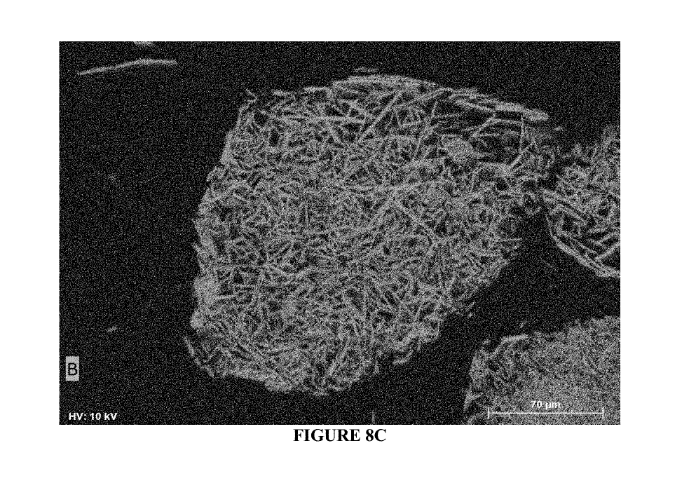

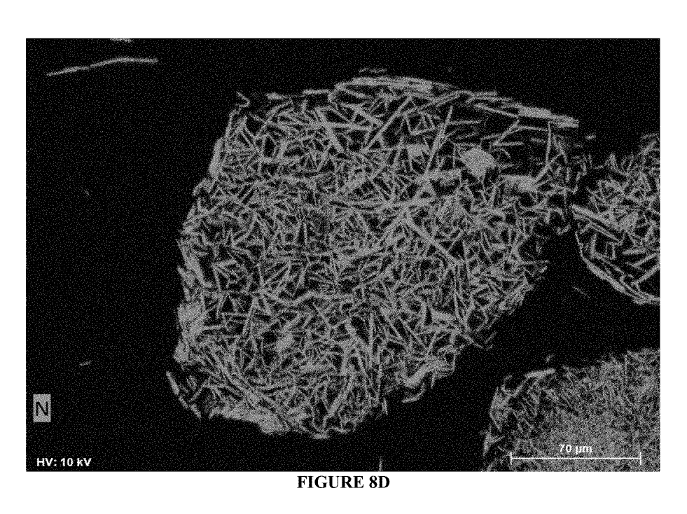

PCTL7MHF BN powder commercialized by Saint-Gobain was subjected to a heat treatment in an elevator furnace under static air in a cycle having a heating rate of 300° C./h up to 1100° C., a holding time of 1 hour at this temperature, and a descent at 300° C./h. The powder bed height was 1 cm. In the end, the powder of example 5 was sieved so as to keep the particle size range between 50 μm and 150 μm. FIGS. 7A-7G are scanning electron microscope (SEM) images of a cross-section of the BN—B₂O₃ powder of Example 5. FIG. 8A is an EDS mapping image displaying oxygen content of a cross-section of the BN—B₂O₃ powder of Example 5. FIG. 8B is an EDS mapping image displaying carbon, nitrogen, boron, and oxygen content of a cross-section of the BN—B₂O₃ powder of Example 5. FIG. 8C is an EDS mapping image displaying boron content of a cross-section of the BN—B₂O₃ powder of Example 5. FIG. 8D is an EDS mapping image displaying nitrogen content of a cross-section of the BN—B₂O₃ powder of Example 5.

The following Table 5 includes properties of the powders of comparative examples 1-3 and examples 4-5.

TABLE 5

| | Example | | | | |
|---|---|---|---|---|---|
| | 1 | 2 | 3 | 4 | 5 |
| B (%) | 42 | 44 | 40 | 44 | 44 |
| N (%) | 51 | 56 | 40 | 53 | 51 |
| O (%) | 5 | <0.1 | 20 | 3 | 5 |
| Oxygen homogeneity | 100 | N/A | 20 | N/A | 100 |
| index | | | | | |
| Other elements (%) | 2 | <0.1 | <0.1 | <0.1 | <0.1 |
| Loss on ignition at | 3 | <0.1 | <0.1 | <0.1 | <0.1 |
| 500° C. (%) | | | | | |
| Hexagonal boron nitride | 100 | 100 | 100 | 100 | 100 |
| Sphericity | 0.85 | 0.85 | 0.85 | 0.85 | 0.85 |
| Specific surface area | 30 | 3 | 1.5 | 3 | 3 |
| (m²/g) | | | | | |
| Open porosity (%) | 70 | 55 | 45 | 55 | 55 |
| Average aggregate size | 120 | 120 | 120 | 120 | 120 |
| (μm) | | | | | |

The BN—B₂O₃ powders of comparative examples 1-3 and examples 4-5 were then used as a filler in a polymer matrix of the TSE3033 silicone resin type commercialized by Momentive Performance Materials. Each powder was dispersed in the TSE3033 silicone resin (the two parts A and B of the resin being mixed in equal quantity by weight) at ambient temperature in a Rayneri VMI Turbotest mixer marketed by the VMI at a speed of rotation of 200 revolutions per minute. The weight of powder introduced was equal to 40% on the basis of the sum of the weight of the TSE3033 silicone resin and the weight of the powder. Each mixture obtained was then cast so as to obtain a film having a thickness of 5 mm. The films were then heated at a temperature of 100° C. for a time period of 2 hours. Measurements for thermal conductivity and volume resistivity were measured for each of the films and are included in the following Table 6 below.

TABLE 6

| | | | | | Water | | | |
|---|---|---|---|---|---|---|---|---|
| | | LOI at | | Open | contact | | Volume | Thermal |
| | | 500° C. | SSA | porosity | angle | Attrition | resistivity | conductivity |
| example | O (%) | (%) | (m²/g) | (%) | (°) | (%) | (Ω · cm) | (W/m · K) |
| 1 | 5 | 3 | 30 | 70 | Not | 100 | 10¹² | 0.4 |
| | | | | | available | | | |
| 2 | <0.1 | <0.1 | 3 | 55 | 95 | 40 | 10¹⁴ | 0.9 |
| 3 | 20 | <0.1 | 1.5 | 45 | 55 | 5 | 10¹³ | 0.5 |
| 4 | 3 | <0.1 | 3 | 55 | Not | 10 | 10¹⁴ | 1.4 |
| | | | | | available | | | |
| 5 | 5 | <0.1 | 3 | 55 | Not | 10 | 10¹⁴ | 1.3 |
| | | | | | available | | | |

### Testing Methods

Unless otherwise specified herein, reference to any of the following characteristics below in the description above and the claims appended hereto refer to values obtained using the following tests:

Chemical composition can be measured conventionally by inductively coupled plasma atomic emission spectrometry (ICP-AES). The elements N and O can also be measured using a LECO series TC 436DR apparatus and the element C can also be measured by a LECO series SC 144DR apparatus.

Boron oxide content can be measured conventionally by Karl-Fischer titration with Mannitol. In addition, boron oxide content can be calculated by multiplying the oxygen content by 1.45 in order to account for the three oxygens in boron oxide.

Structural composition can be obtained by X-ray diffraction and Rietvled refinement.

Specific surface area can be measured by nitrogen adsorption at 77K with a Tristar II apparatus commercialized by Micromeritics company.

Water contact angle can be measured on pressed parts. The pressed part can be made by uniaxially pressing at 200 MPa 8 g of powder. The contact angle of a water droplet on the pressed part can be measured by DyneX CAM optical tensiometer commercialized by Dyne Technology. In some embodiments, the water contact angle of the pressed BN—B₂O₃ powder disclosed herein can be lower than or equal to about 90°, about 80°, about 70°, about 60°, about 50°, or about 40°. In some embodiments, the water contact angle of the pressed BN—B₂O₃ powder disclosed herein can be about greater than or equal to about 10°, about 20°, or about 30°. In some embodiments, the water contact angles of the pressed BN—B₂O₃ powder disclosed herein can be about 10-90°, about 20-80°, or about 30-70°.

The oxygen homogeneity index can be measured on a polished section of the aggregates molded into an epoxy resin and viewing the sample using a Zeiss Merlin SEM-EDS, at a voltage between 5.0 and 10.0 kV, with a working distance between 3-7 mm, to create images of the Oxygen mapping for analysis. The image characteristics include an image width of 500 microns and a resolution of 1024 pixels×768 pixels. The oxygen EDS mapping is taken in a manner to maximize the contrast between the polymer resin, the second phase (boron nitride) and the third phase material (e.g., boron oxide), such that the grains of the second phase are darker than the resin, and that the resin is darker than the third phase. Using suitable image analysis software, such as ImageJ 1.48 v available from NIH, crop the image to remove any labels, and adjust the image to increase the brightness of the third phase to facilitate selection of only the bright material associated with the third phase. Use the image analysis software to change the image to a binary image (i.e., black and white). Using analysis software, such as Image J, quantify the image statistics using the following approach: Step 1) using Analyze process in ImageJ; step 2) use “Analyze Particles” in ImageJ, and use settings as size (pize1̂2): 0-infinity and circularity: 0-1; step 3) compare calculated area from output. It will be appreciated that multiple images of randomly selected portions can be analyzed. For example, the values provided herein can be calculated from at least 5 different SEM images of randomly selected portions of a sample. The oxygen homogeneity index is given by the ratio between the total area of the image, based on a EDS-SEM image of 500 microns in total width and using the resolution noted above (1024×768) and the third phase area (in pixels). FIG. 8A is an EDS mapping image displaying oxygen content of a cross-section of the BN—B₂O₃ powder of Example 5. FIG. 8B is an EDS mapping image displaying carbon, nitrogen, boron, and oxygen content of a cross-section of the BN—B₂O₃ powder of Example 5. FIG. 8C is an EDS mapping image displaying boron content of a cross-section of the BN—B₂O₃ powder of Example 5. FIG. 8D is an EDS mapping image displaying nitrogen content of a cross-section of the BN—B₂O₃ powder of Example 5.

Sphericity can be measured by a manual or automated observation of photographs of the powder, for example, using a Morphologi® G3 S apparatus commercialized by the Malvern or a CamSizer apparatus commercialized by Retsch technologies. Such apparatuses also makes it possible to determine the mean sphericity of the powder.

The powder porosity can be evaluated by mercury porosimetry according to the standard ISO 15901-1.

The wear by attrition of the powder can be estimated using the following test: 20 g of powder passing through the mesh openings of a sieve with 500 μm openings and not passing through the mesh openings of a sieve with 150 μm openings are placed in a closed nylon container so that the powder occupies 45% of the volume of the container. The container is then stirred for 120 minutes at a rotational speed of 20 rpm in a jar turner. After the test, the weight of the particles passing through the mesh openings of a sieve with 150 μm openings is determined. The particles passing through correspond to the quantity of fine particles created in the test. This quantity of fine particles generated, or “wear by attrition,” is expressed as percentage of the weight of the powder before the test. The higher the quantity of fine particles generated during the test, the greater the wear by attrition of the powder.

The (“through plane”) thermal conductivity can be determined by the product of the through plane thermal diffusivity, the density, and the thermal capacity. The thermal diffusivity can be measured according to the standard ASTM C-518 using the thermal flow method. The thermal diffusivity is measured perpendicularly to the polymer layer (i.e., through plane thermal diffusivity). The thermal capacity of the polymers can be measured by differential scanning calorimetry using a Netzsch thermobalance. The density can be measured by helium pycnometry.

Tap density can be measured according to ISO 23145-1:2007.

Bulk density can be by mercury porosimetry (volumetric mass taking into account the porosity below 1 micron).

Flowability can be measured according to ISO 14629:2012.

Volume resistivity can be measured according to ASTM D257.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. Finally, the entire disclosure of the patents and publications referred in this application are hereby incorporated herein by reference.

1. A powder comprising:
90-99 wt % boron nitride; and
1-10 wt % boron oxide,
wherein the powder has an open porosity of 30-70%.

2. The powder of claim 1, wherein the boron oxide comprises 2-6 wt % of the powder.

3. The powder of claim 1, wherein the powder has a surface area of 1-5 m²/g.

4. The powder of claim 1, wherein the open porosity of the powder is 40-60%.

5. The powder of claim 1, wherein an oxygen homogeneity index of the powder is greater than 100.

6. The powder of claim 1, wherein a sphericity of the powder is at least above 0.8.

7. The powder of claim 1, wherein the powder comprises 41-45 wt % elemental boron, 48-54 wt % elemental nitrogen, and 1-6 wt % elemental oxygen.

8. The powder of claim 7, wherein the powder comprises less than 0.1 wt % impurities.

9. The powder of claim 1, wherein an average size of aggregates of the powder is 50-250 microns.

10. A method of forming a BN—B₂O₃ powder comprising:
heat treating a high fired boron nitride (BN) powder at a temperature of 800-1200° C. for a period of 1-5 hours.

11. The method of claim 10, wherein an atmosphere for the heat treating has a partial pressure of oxygen of at least 100 Pa and a partial pressure of water of at most 1000 Pa.

12. The method of claim 10, wherein the heat treating further comprises heating the high fired BN powder at a rate of 100-500° C./hr until the temperature is reached.

13. The method of claim 10, further comprising cooling the formed BN—B₂O₃ powder at a rate of 200-400° C./hr.

14. The method of claim 10, wherein the heat treating takes place in a rotary kiln, a muffle furnace, an elevator kiln, or a pusher kiln.

15. The method of claim 14, wherein a powder bed height in the kiln or furnace is below at least 5 cm.

16. The method of claim 10, wherein the high fired BN powder comprises less than 1 wt % oxygen.

17. The method of claim 10, wherein the high fired BN powder comprises less than 0.1 wt % boron oxide.

18. The method of claim 10, wherein the high fired BN powder has a surface area of 1-5 m²/g.

19. The method of claim 10, wherein the high fired BN powder has a porosity of 40-60%.

20. The method of claim 10, wherein the high fired BN powder has a sphericity above 0.8.

21. The method of claim 10, wherein the BN—B₂O₃ powder comprises 94-96 wt % boron nitride and 2-6 wt % boron oxide.

22. The method of claim 10, wherein an oxygen homogeneity index of the BN—B₂O₃ powder is greater than 100.

23. The method of claim 10, wherein the BN—B₂O₃ powder comprises 41-45 wt % the element boron, 48-54 wt % the element nitrogen, and 1-5 wt % the element oxygen.

24. The method of claim 23, wherein the BN—B₂O₃ powder comprises less than 0.1 wt % impurities.

25. The powder of claim 1, wherein the powder has a loss on ignition at 500° C. of less than 2 wt. %
